(19) United States
(12) Patent Application Publication
(10) Pub. No.: US 2003/0002578 A1
(43) Pub. Date: Jan. 2, 2003

(54) System and method for timeshifting the encoding/decoding of audio/visual signals in real-time

(76) Inventors: Ikuo Tsukagoshi, Tokyo, CA (US); Klaus Zimmermann, Deizisau (DE)

Correspondence Address: Sony Electronics Inc., Intellectual Property Department, 16450 West Bernardo Drive, MZ 7190, San Diego, CA, 92127-1898, US

(21) Appl. No.: 10/014,732

(22) Filed: Dec. 11, 2001

Related U.S. Application Data
(60) Provisional application No. 60/254,951, filed on Dec. 11, 2000.
(60) Provisional application No. 60/254,831, filed on Dec. 11, 2000.

(51) Int. Cl. H04B 1/66; H04N 7/12; H04N 11/02; H04N 11/04

(52) U.S. Cl. 375/240.01; 375/240; 348/384.1

(57) ABSTRACT

A system and method for timeshifting the encoding and decoding of a compressed audio/video bitstream are described. In one embodiment, the compressed audio/video bitstream is encoded and stored. After a period of time, the encoded bitstream is retrieved and decoded.

### RELATED APPLICATIONS

The present application claims the benefit of U.S. Provisional Patent Applications Serial No. 60/254,951, filed on Dec. 11, 2000, and entitled “DISPLAY SWITCH CONTROL FOR TIME SHIFTING APPLICATION” and U.S. patent application Ser. No. 60/254,831, filed on Dec. 11, 2000, and entitled “SOFTWARE TIME SHIFTING ON ONE-CHIP PLATFORM”, which are herein incorporated by reference in their entirety.

### FIELD OF THE INVENTION

The present intention relates to the design of encoding/decoding systems. More specifically, the present invention pertains to a software timeshifting system.

### BACKGROUND OF THE INVENTION

The ever-increasing demand for high-quality audio video media has fueled the advent of audio and video storage and retrieval technology. In particular, one popular set of standards for audio and video compression is the MPEG (moving pictures experts group) standard. Today, there are several versions of the MPEG standard, each designed for different applications. Specifically, MPEG-2 is designed for high bandwidth applications such as broadcast television including high-definition television (HDTV). In order to listen and to view the content in an MPEG-2 transport stream, a system capable of encoding and decoding the compressed audio video data is essential.

Recently, digital recording of audiovisual broadcast signals on nonvolatile storage media such as hard disk drives has become highly popular. The storage medium allows one to decode the stored information in a time delayed fashion. These recorders are commonly referred to as timeshifting systems. The absolute delay or shift in time is determined by the storage capacity and recording format of the system.

Conventional real-time timeshifting systems make use of separate encoder an decoder hardware devices. The use of these dedicated devices result in a commitment to the coding and storage formats used by these devices. For example, an encoder device might store the encoded signal as an MPEG-2 transport stream on the storage medium. However, this type of system cannot support different stream formats. Additionally, a host CPU must control these separate devices and the storage medium for simultaneous encoding and time-shifted decoding in real-time. Also, the different hardware devices all require their own memory block.

There are several PC-based timeshifting system solutions available. These timeshifting systems require several external input/output devices (video capture card, soundcard, graphics card, and video output card) together with the main CPU. Furthermore, PC-based timeshifting systems cannot be regarded as true real-time systems as they lack the fundamental concept of “time”. Due to this lack, PC-based timeshifting systems cannot handle time stamps. In addition, the processing and presentation time of individual data blocks is nondeterministic on these timeshifting systems.

What is required is a system and method that combines all functional blocks of real-time timeshifting systems.

### SUMMARY OF THE INVENTION

A system and method for timeshifting the encoding and decoding of a compressed audio/video bitstream are described. In one embodiment, the compressed audio/video bitstream is encoded and stored. After a period of time, the encoded bitstream is retrieved and decoded.

Other features and advantages of the present invention will be apparent from the accompanying drawings and from the detailed description that follows.

### BRIEF DESCRIPTION OF THE DRAWINGS

FIG. 1a is a block diagram of one embodiment for a computer architecture.

FIG. 1b is a block diagram of one embodiment for a timeshifting system.

FIG. 2 is a block diagram of one embodiment for an encoder module of FIG. 1b.

FIG. 3 is a block diagram of one embodiment of storage or transmission medium of FIG. 1b.

FIG. 4 is a block diagram of one embodiment of the decoder module of FIG. 1b.

FIG. 5 is a thread execution diagram showing the interaction between different temporal relationships of the timeshifting system of FIG. 1b.

FIG. 6 is a control flow diagram illustrating exemplary control flow among functional modules in the software-based timeshifting system of FIG. 1b.

FIG. 7 is a flow diagram of one embodiment for the timeshifting of the encoding and decoding of a bitstream.

### DETAILED DESCRIPTION

A system and method for timeshifting the encoding and decoding of a compressed audio/video bitstream are described. In one embodiment, the compressed audio/video bitstream is encoded and stored. After a period of time, the encoded bitstream is retrieved and decoded.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

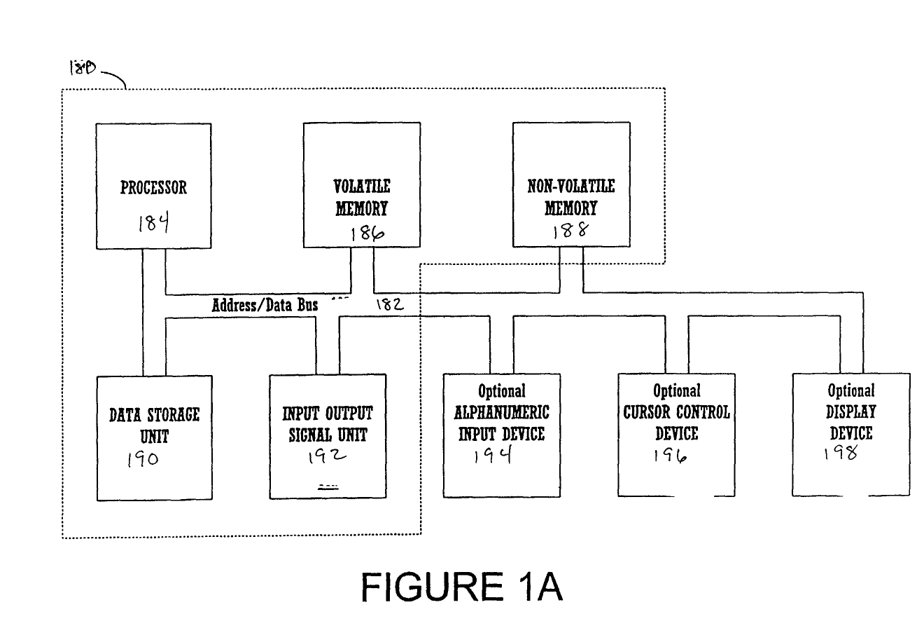

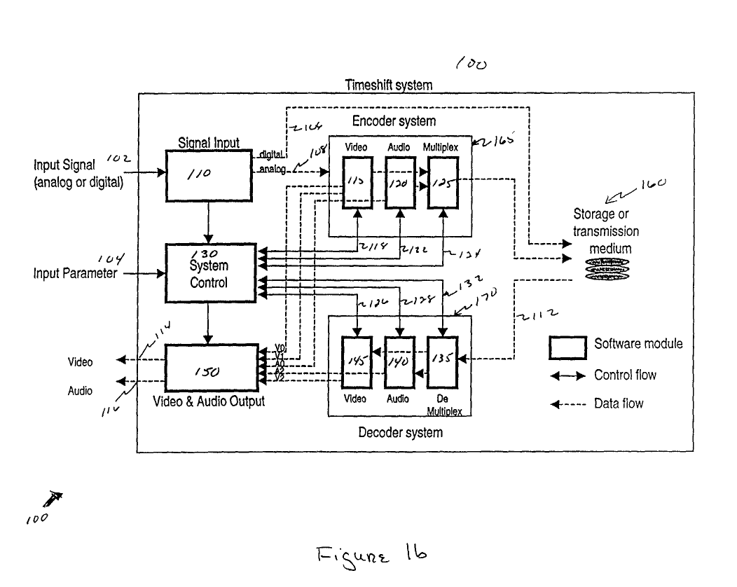

FIG. 1a is a block diagram of one embodiment for a computer architecture. Referring to FIG. 1a, computer system 180 includes an address/data bus 182 for communicating information, central processing unit (CPU) 184 coupled with bus 182 for processing information and instructions, volatile memory 186 (e.g., random access memory RAM) coupled with bus 182 for storing information and instructions for CPU 184 any nonvolatile memory 188 (e.g., read-only memory ROM) coupled with bus 182 for storing static information and instructions for CPU 184. In accordance with the embodiments described herein, CPU 184 is a single processor having a single instruction pointer.

Computer system 180 also includes a data storage device 190 (“disk subsystem”) such as, for example, a magnetic or optical disk or any storage device coupled with bus 182 for storing information instructions. Data storage device 190 includes one or more removable magnetic or optical storage media (for example, diskettes, tapes, or the like) which are computer readable memories. In accordance of the embodiments described herein, data storage device 190 may contain a bitstream of encoded information. Memory units of system 180 include 186, 188, and 190. Computer system 180 may also include a signal input output communication device 192 (for example, modem, network interface card NIC) coupled to bus 182 for interfacing with other computer systems. In accordance with the embodiments described herein, signal input/output communication device 192 may receive an incoming encoded bitstream.

Also included in computer system 180 is an optional alphanumeric input device 194 including alphanumeric and function keys coupled to bus 182 for communicating information and command selections to CPU 184. Computer system 180 also includes an optional cursor control or directing device 196 coupled to bus 182 for communicating user input information and command selections to CPU 184. An optional display device 198 may also be coupled to bus 182 for displaying information to the computer user. Display device 198 may be a liquid crystal device, other flat-panel display, cathode ray tube, or other display device suitable for creating graphic images and alphanumeric characters recognizable to the user. Cursor control device 196 allows the computer user to dynamically signal a two-dimensional movement of a visible symbol (cursor) on a display screen or display device 198. Many implementations of cursor control device 196 are well-known in the art including a trackball, mouse, touchpad, joystick, or special keys on alphanumeric input device 194 capable of signaling movement of a given direction or manner of displacement. Alternatively, it will be appreciated that the cursor may be directed or activated via input from alphanumeric input device 194 using special keys in key sequence commands. The present invention is also well suited to direct a cursor by other means such as, for example, voice commands.

It is appreciated the computer system 180 described herein illustrates an exemplary configuration of an operational platform upon which embodiments described herein may be implemented. Nevertheless, other computer systems with different configurations may also be used to place a computer system 180 within the scope of the embodiments.

FIG. 1b is a block diagram of one embodiment for a software-based, timeshifting system 100. Referring to FIG. 1b, an analog or digital input signal 102 is received at signal input 110. Analog signals 108 are received and encoded by encoder system 165 and stored in storage or transmission medium 160. Encoded signals are retrieved from storage or transmission medium 160 and transferred to decoder system 170. Decoder signals are transferred to video and audio output 150. Control of the system is handle by system control 130. In one embodiment, timeshifting system 100 may be implemented on a single processor requiring only one unified memory block 160. In addition, timeshifting system 100 accepts a variety of different input signal formats such as, for example, MPEG-2, MPEG-4, digital video (DV), and the like. Input signal 102 may be either analog or digital. Storage transmission medium 160 may be volatile or nonvolatile storage media. Timeshifting system 100 consists of multiple functional blocks. In one embodiment, the basic system 100 depends on the system configuration and environment as described in Table 1 below.

TABLE 1

| System | | | |
|---|---|---|---|
| Configuration | Audio Only | Video Only | Audio and Video |
| Analog | Audio Input, | Video Input | Audio Input, |
| Timeshift | Audio Encoder, | Video Encoder, | Video Input, |
| | Multiplexer, | Multiplexer, | Audio Encoder, |
| | Demultiplexer, | Demultiplexer, | Video Encoder, |
| | Audio Decoder, | Video Decoder, | Multiplexer, |
| | Audio Output | Video Output | Demultiplexer, |
| | | | Audio Decoder, |
| | | | Video Decoder, |
| | | | Audio Output, |
| | | | Video Output |
| Digital | Stream Input, | Stream Input, | Stream Input, |
| Timeshift | Demultiplexer, | Demultiplexer, | Demultiplexer, |
| | Audio Decoder, | Video Decoder, | Audio Decoder, |
| | Audio Output | Video Output | Video Decoder, |
| | | | Audio Output, |
| | | | Video Output |

Individual functional blocks makeup system modules. In one embodiment, there are two functional modules in the A/V timeshifting system: encoder module 165 and decoder module 170. Encoder module 165 consists of audio input, audio encoder 120, video input, video encoder 115 and multiplexer 125. Decoder module 170 consists of demultiplexer 135, audio decoder 140, audio output, video decoder 145, and video output.

In one embodiment, encoder 165 process the incoming baseband signals 108 and converts the input signals into a digital bitstream according to the specific coding format for the audio data and video data, respectively. Encoder module 165 processes and writes segments of data to storage or transmission medium 160. In one embodiment, these segments of data are called access units. There is one access unit generated per audio/video frame. Depending on the coding format of the output data from encoder 165, the bitstream may contain additional stream information such as time stamps and program tables. In one embodiment, timeshifting system 100 employs at delay module, which is suitable to handle all types encoder module 165 output formats.

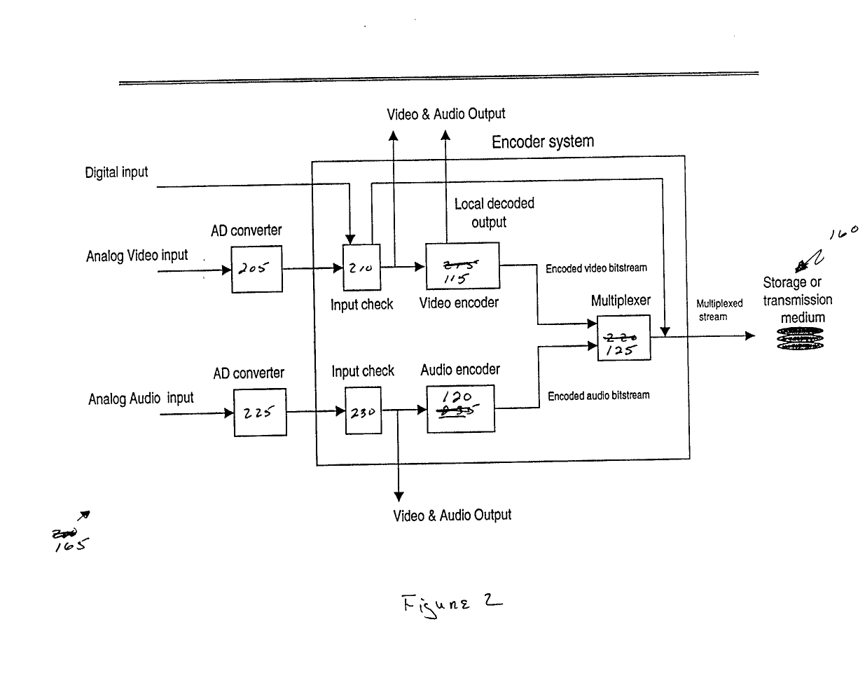

FIG. 2 is a block diagram of one embodiment for encoder module 165. Referring to FIG. 2, analog video input is received at analog-to-digital (A/D) converter 205. A/D converter 205 converts the analog video signal from analog to digital format. The digital output from A/D converter 205 is transferred to input check 210 and subsequently sent to video encoder 115. Analog audio input is received in A/D converter 225 and converted from analog to digital format. The converted audio data is sent to input check 230 and subsequently to audio encoder 120. Encoded video data and encoded audio data are multiplexed by multiplexer 125 and stored in storage or transmission medium 160.

While encoder module 165 is writing the bitstream into storage or transmission medium 160, encoder module 165 generates additional control information to support timeshifting. During encoding, encoder module 165 assembles the characteristics for every access unit and access unit descriptor. These characteristics include, for example, the access unit type, the access unit size, the recording bitrate for the access unit, a scene change flag for video signals, and the position of the first byte of the access unit in storage or transmission medium 160. Encoder module 165 stores the individual descriptors into a dynamic data structure. In one embodiment, there is a one-to-one correspondence between the access unit descriptors and the access units in the bitstream.

In addition, descriptors contain links to their predecessors and successors within the list. These links allow instant access to all access units within the bitstream. In addition, an individual descriptor might also contain links to several predecessors and successors depending on the supported search criteria of timeshifting system 100. In one embodiment, timeshifting system 100 supports searching for every frame, only anchor frames, and only seen change frames. For example, if it is desired to access scene changes only, descriptors will have additional links to the next and previous access unit descriptors, which represent the first encoded video frames after a scene change.

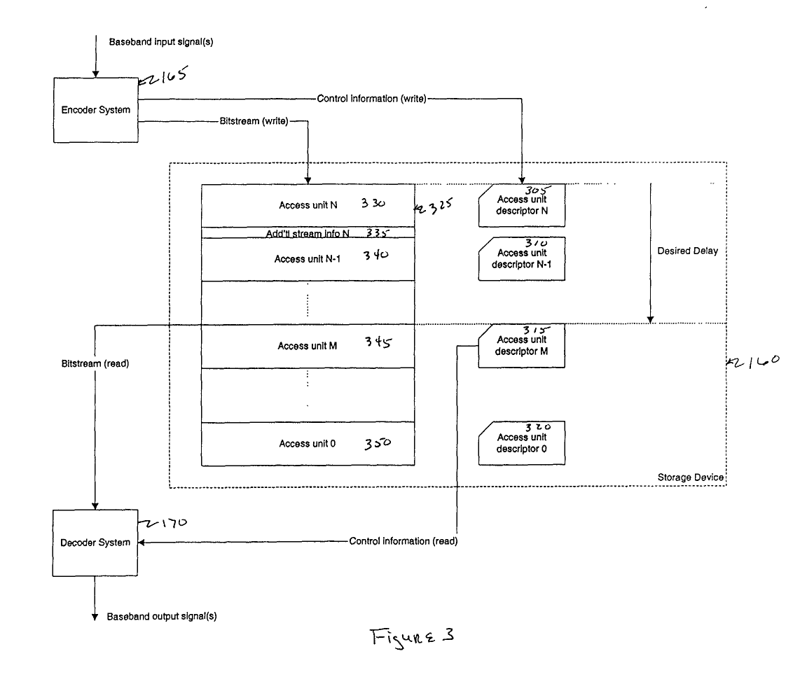

FIG. 3 is a block diagram of one embodiment of storage or transmission medium 160. Encoder module 165 sends stream control information to access unit descriptors 305 through 320. In addition, encoder module 165 writes the bitstream to access unit storage area 325. Upon playback, decoder system 170 accesses access unit descriptors 305 through 320 to determine the stream position to begin decoding. In one embodiment, the user may specify the starting position by choosing the desired delay between the recording and playback or by scanning the storage media 160 in one of the trick-play modes available within timeshifting system 100.

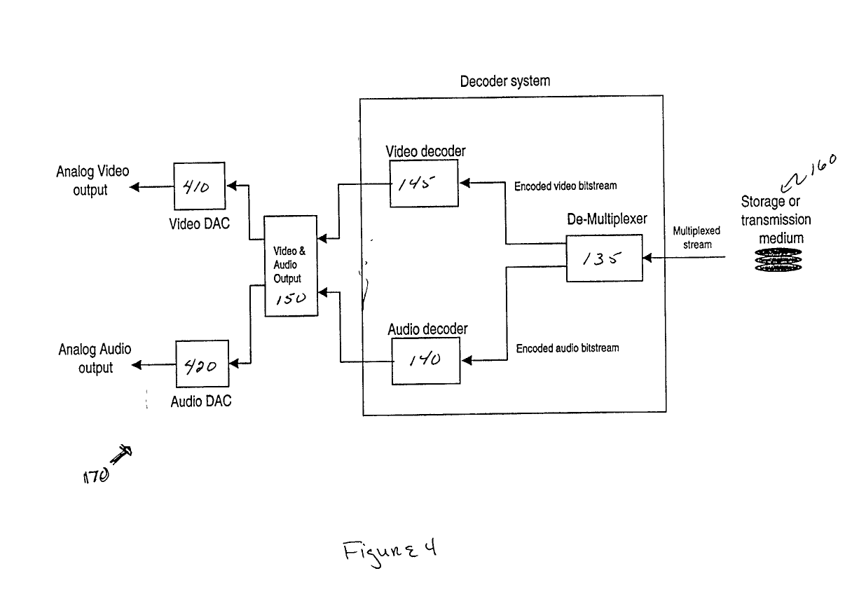

FIG. 4 is a block diagram of one embodiment of decoder module 170. Referring to FIG. 4, decoder module 170 includes demultiplexer 135, video decoder 145, audio decoder 140, video and audio output 150, video DAC 410, and audio DAC 420. In one embodiment, the decode position within storage or transmission medium 160 is determined every time the demultiplexer 135 is activated. Demultiplexer 135 begins processing the bitstream at the location specified in the selected access unit descriptor 305 through 320. Demultiplexer 135 output is fed to audio decoder 140 and video decoder 145. Audio decoder 140 and video decoder 145 operate independently. Decoded video data is transferred to video and audio output 150 and subsequently output as video data 410. Decoded audio data is transferred to video output 150 and subsequently output as audio data 420.

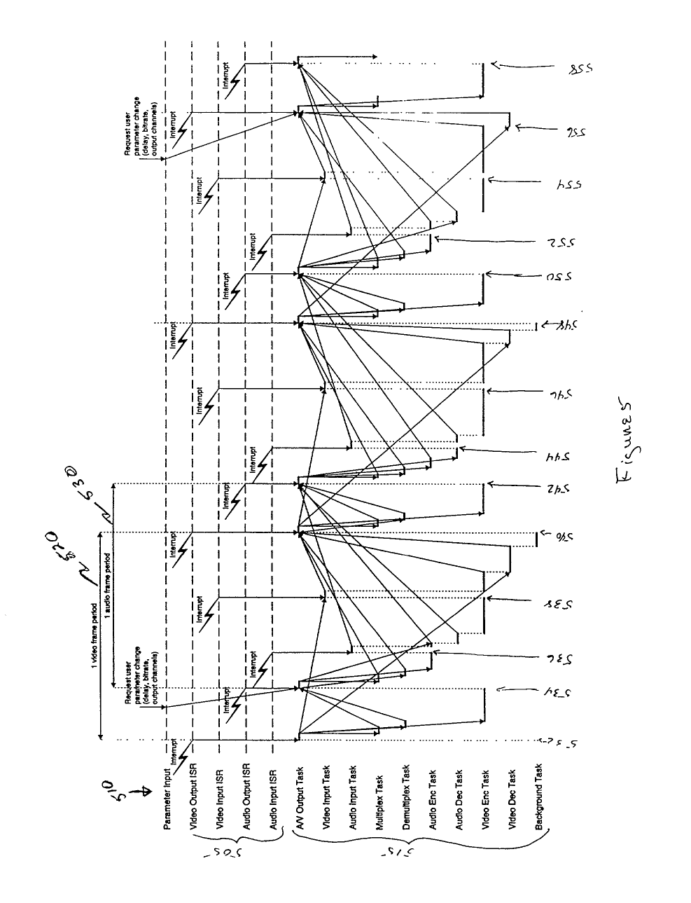

FIG. 5 is a thread execution diagram showing the temporal relationships between the different functional blocks of timeshifting system 100. Referring to FIG. 5, in one embodiment, every functional block listed in Table 1 above is implemented as an individual thread within timeshifting system 100. Task execution for each system module 515 is shown as a thread and is indicated as a horizontal solid line. The concept of multiple threading is applied to timeshifting system 100. In one embodiment, a single processor with a single instruction pointer is used such that only one thread may be run at a time. However, execution is perceived as if multiple threads are executed in parallel. In one embodiment, a real-time operating system kernel schedules the processing of the threads. In one embodiment, the system kernel contains four interrupt service routines (ISR) 505 for controlling the timeshifting between each system module 515.

In one embodiment, timeshifting system 100 is completely input/output driven. Individual threads are executed based on the arrival of interrupts 532 through 558 generated by ISRs 505. Note that only one thread of execution may be performed at any given time as the CPU of system 100 has a single instruction pointer. Thus, in FIG. 5, there exists no overlap of horizontal time segments, indicating that only one functional module 515 may be executing a task at any given time.

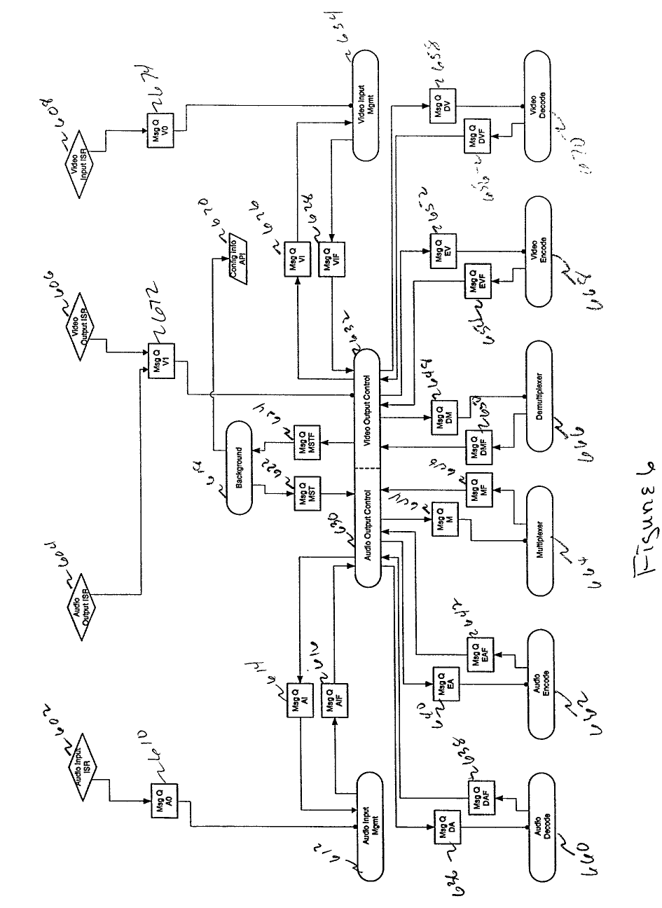

FIG. 6 is a control flow diagram illustrating exemplary control flow among functional modules in a software-based timeshifting system 100. Referring to FIG. 6, in one embodiment, if timeshifting system 100 processes audio and video input signals simultaneously, four I/O devices 602, 604, 606, and 608 are active and running in parallel. The input devices 602 and 608 generate interrupts whenever frame buffer has been filled with data. Similarly, the output devices 604 and 606 generate interrupts whenever the frame buffer has been output through the input devices 602 and 608.

In one embodiment, there is strict separation between the audio and video processing threads. The separation is achieved by maintaining two independent time bases in timeshifting system 100, one for audio and one for video. The audio interfaces establish the audio time base whereas the video interfaces establish the video time base. In this embodiment, the two different time bases are inherently different due to the nature of the formats. The different time bases are depicted in FIG. 6. Due to this time-based independence, system 100 is able to support audio only, video only, and mixed (audio and video) signal configurations.

Individual threads communicate with each other through message queues. In one embodiment, because the system is purely input/output driven, the interrupts generated by the input/output interfaces and message queues (A0, V0, and V1) control the execution of the input/output threads. Timeshifting system 100 uses a static configuration that is passed from background thread 618 via message queue MST 622 at system startup. The configuration parameters are then distributed to the individual threads through message queues originating in the A/V output thread. This thread also collects all the threads' feedback status messages and reports then to the background thread. The background thread reacts to the status messages by reconfiguring the system through subsequent MST messages. Table 2 lists examples of the message queues employed by timeshifting system 100.

TABLE 2

| Message Queue Name | Function | Message Data |
|---|---|---|
| MST | System (static) | System configuration |
| | configuration | parameters |
| MSTF | System feedback | System status |
| A0 | Audio input execution | Time stamp |
| | timing | |
| V0 | Video input execution | Time stamp |
| | timing | |
| V1 | Audio/Video output | Time stamp |
| | execution timing | |
| A1 | Audio input | Input configuration |
| | configuration | parameters |
| AIF | Audio input thread | Status, data buffer |
| | feedback | information |
| VI | Video input | Input configuration |
| | configuration | parameters |
| VIF | Video input thread | Status, data buffer |
| | feedback | information |
| EA | Audio encoder thread | Command (initialize, |
| | control | encode, etc.) |
| EAF | Audio encoder thread | Status, data buffer |
| | feedback | information |
| EV | Video encoder thread | Command (initialize, |
| | control | encode, etc.) |
| EVF | Video encoder thread | Status, data buffer |
| | feedback | information |
| M | Multiplexer thread | Command (initialize, |
| | control | multiplex, etc.), data |
| | | buffer information |
| MF | Multiplexer thread | Status, data buffer |
| | feedback | information |
| DM | Demultiplexer thread | Command (initialize, |
| | control | demultiplex, etc.), data |
| | | buffer information |
| DMF | Demultiplexer thread | Status, data buffer |
| | feedback | information |
| DA | Audio decoder thread | Command (initialize, |
| | control | decode, etc.) |
| DAF | Audio decoder thread | Status, data buffer |
| | feedback | information |
| DV | Video decoder thread | Command (initialize, |
| | control | decode, etc.) |
| DVF | Video decoder thread | Status, data buffer |
| | feedback | information |

In one embodiment, video input ISR 608 receives an interrupt from system control 130 that input data has been received by signal input 110. Video input ISR 608 sends message V0 via message queue V0 674 to video input manager 634 to begin processing the video input stream. Video input manager 634 sends feedback message VIF via message queue VIF 628 to video output control 632. Video output control 632 sends message EV via message queue EV 652 to video encoder 668 to begin the video encoding thread once the data input buffer is full. Feedback message EVF is sent via message queue EVF 654 to video output control 632 with status and buffer information. Video encoder 115 begins video encoder thread 668 to encode the input video stream. Video encoder 115 processes the input video stream for a set period of time set by message MST. Parameters within message MST are set either at system start-up or by the user during the encoding/decoding process.

Once the time period for video input has elapsed, audio input ISR 602 sends message A0 via message queue A0 610 to audio input manager 612 for audio input manager 612 to begin processing the audio input stream. Audio input manager 612 sends feedback message AIF via message queue AIF 616 to audio output control 630. Audio output control 630 sends feedback message A1 via message queue A1 614 to audio input manager 612 and sends message EA via message queue EA 640 to audio encoder 120 to begin processing audio encoder thread 662. Audio encoder thread 662 sends feedback message EAF via message queue EAF 642 to audio output control 630 and processes the audio input for a set period of time set by message MST.

Once the time period for audio input has elapsed, audio output control 630 sends message M via message queue M 644 to multiplexer 125 for multiplexer 125 to begin multiplexing thread 664. Multiplexing thread 664 sends feedback message MF via message queue MF 648 to audio output control 630 and multiplexes the encoded video and audio streams, sending the multiplexed bitstream to storage or transmission medium 160. Multiplexing thread 664 continues multiplexing the streams for a set period of time set by MST.

After the multiplexing thread 664 time period has elapsed, system control 130 sends an interrupt to the encoder 165 to stop processing and sends message V1 via message queue V1 672 to video output control 632. Video output control 632 sends message DM via message queue DM 648 to demultiplexer 135 to begin demultiplexing thread 666. Demultiplexing thread 666 sends feedback message DMF via message queue DMF 650 to video output control 632. Demultiplexing thread 666 retrieves the access unit 325 pointed to by the access unit pointer together with the access unit descriptor information for the access unit from storage or transmission medium 160. Demultiplexing thread 666 processes the access unit 325 for a given period of time set by MST.

After the time period for demultiplexing has elapsed, control is transferred to video decoder 145. Video output control 632 sends message DV via message queue DV 658 to video decoder 145 for video decoder 145 to begin video decoder thread 670. Video decoder thread 670 processes the demultiplexed output video stream for a period of time set by MST. Video decoder thread 670 sends feedback message DVF via message queue DVF 656 to video output control 632 and processes the video stream. The output video stream is sent to video and audio output 150.

After the time period for output video decoding has elapsed, control is transferred to audio decoder 140. Audio output control 630 sends audio decoder 140 message DA via message queue DA 636 for audio decoder 140 to begin audio decoder thread 660. Audio decoder thread 660 processes the demultiplexed audio stream for a period of time set by message MST. Audio decoder thread 660 sends the output audio to video and audio output 150. Audio decoder thread 660 sends feedback message DAF via message queue DAF 638 to audio output control 630. Audio decoder thread 660 continues processing the output audio until the time period set by MST has elapsed.

Video and audio output 150 outputs the video stream 114 and the audio stream 116 to output display devices at a given frame rate for the output devices. Thus, in one embodiment, an input frame of data is encoded for a given period of time set by MST at system startup by background 618. The encoded input stream is stored in storage or transmission medium 160. After a period of time set by MST, the decoding process begins and a frame of encoded data (access unit) is retrieved from storage or transmission medium 160, decoded by decoder device 170, and sent to video and audio output 150.

The input interfaces and the corresponding output interfaces are synchronized by mechanism described in application serial number ___/___,___, entitled “System and Method for Effectively Performing an Audio/Video Synchronization Procedure” which is herein incorporated by reference. This synchronization mechanism, in combination with the independence of audio and video processing, prevents the buffer from over- or under-flowing within timeshifting system 100 as long as real-time requirements are met. Both input threads (the audio input thread 662 and the video input thread 668) may detect a valid input signal at their respective I/O interfaces (602, 608). If there is no signal or an invalid input signal, the particular input thread will not pass any data to the encoder thread (662 and 668 respectively). The input thread data passing will resume once the input logic detects a valid signal at the input device.

In one embodiment, a user may interact with timeshifting system 100 by specifying a system parameter string during runtime. The modifiable parameters may be, for example, time delay, recording bitrate, and output channel. Timeshifting system 100 scans these parameters each time the A/V output thread 630, 632 is active. The output thread 630, 632 responds to the user input by reconfiguring timeshifting system 100 according to the user request. For example, if the user changes the time delay, the A/V output thread 630, 632 scans this parameter. The A/V output thread 630, 632 then passes the delay parameter to demultiplexer thread 666. Demultiplexer thread 666 modifies the position from where it is reading in the stored bitstream according to the specified time delay. In one embodiment, the user input time delay of this polling mechanism may not exceed one video frame, which equals 33 milliseconds for the NTSC format.

System 100 may be implemented in a microprocessor, microcontroller or signal processor with integrated video and audio output interfaces. The processor should be able to handle the schedule threads in real-time. A real-time operating system is running on a processor supporting interrupts, message queues, and task switches.

Timeshifting system 100 has been implemented using MPEG-2 standard to either generate compliant transport stream output or elementary stream outputs (one for audio and one for video) on storage or transmission medium 160. The video Codec utilizing the MPEG-2 video format to generate an MPEG-2 video elementary output stream has also been implemented. The audio Codec utilizes the PC and data format. In one implementation, dynamic input of user parameters to the timeshifting system 100 is handled by an interrupt-based mechanism.

Timeshifting system 100 may be used to perform timeshifting using a variety of different coding schemes and system formats such as, for example, MPEG-1, MPEG-4, DV (digital video), JPEG, Motion JPEG-2000, and the like. For example, it is possible to use a swapout of the audio Codec and replace it by a different Codec. Further, timeshifting system 100 may write to any format external storage or transmission medium 160. For example, timeshifting system 100 may output MPEG-2 A/V elementary streams, if desired. Timeshifting system 100 may also be configured to make use of a volatile storage device (for example, RAM-based recorders).

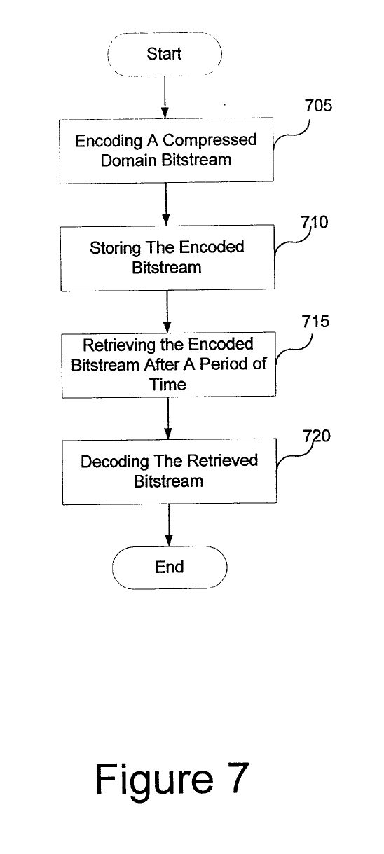

FIG. 7 is a flow diagram of one embodiment for the timeshifting of the encoding and decoding of a bitstream. At processing block 705, a compressed domain bitstream is encoded. Initially, a static configuration is passed from background thread 618 via message queue MST 622 at system startup. Configuration parameters are distributed to the individual threads through message queues originating in the A/V output thread. In one embodiment, if timeshifting system 100 processes audio and video input signals simultaneously, four I/O devices 602, 604, 606, and 608 are active and running in parallel. The input devices 602 and 608 generate interrupts whenever frame buffer has been filled with data. Similarly, the output devices 604 and 606 generate interrupts whenever the frame buffer has been output through the input devices 602 and 608.

In one embodiment, there is strict separation between the audio and video processing threads. The separation is achieved by maintaining two independent time bases in timeshifting system 100, one for audio and one for video. The audio interfaces establish the audio time base whereas the video interfaces establish the video time base. In this embodiment, the two different time bases are inherently different due to the nature of the formats. The different time bases are depicted in FIG. 6. Due to this time-based independence, system 100 is able to support audio only, video only, and mixed (audio and video) signal configurations.

In one embodiment, video input ISR 608 receives an interrupt from system control 130 that input data has been received by signal input 110. Video input ISR 608 sends message V0 via message queue V0 674 to video input manager 634 to begin processing the video input stream. Video input manager 634 sends feedback message VIF via message queue VIF 628 to video output control 632. Video output control 632 sends message EV via message queue EV 652 to video encoder 668 to begin the video encoding thread once the data input buffer is full. Feedback message EVF is sent via message queue EVF 654 to video output control 632 with status and buffer information. Video encoder 115 begins video encoder thread 668 to encode the input video stream. Video encoder 115 processes the input video stream for a set period of time set by message MST. Parameters within message MST are set either at system start-up or by the user during the encoding/decoding process.

Once the time period for video input has elapsed, audio input ISR 602 sends message A0 via message queue A0 610 to audio input manager 612 for audio input manager 612 to begin processing the audio input stream. Audio input manager 612 sends feedback message AIF via message queue AIF 616 to audio output control 630. Audio output control 630 sends feedback message A1 via message queue A1 614 to audio input manager 612 and sends message EA via message queue EA 640 to audio encoder 120 to begin processing audio encoder thread 662. Audio encoder thread 662 sends feedback message EAF via message queue EAF 642 to audio output control 630 and processes the audio input for a set period of time set by message MST.

Once the time period for audio input has elapsed, audio output control 630 sends message M via message queue M 644 to multiplexer 125 for multiplexer 125 to begin multiplexing thread 664. Multiplexing thread 664 sends feedback message MF via message queue MF 648 to audio output control 630 and multiplexes the encoded video and audio streams, sending the multiplexed bitstream to storage or transmission medium 160. Multiplexing thread 664 continues multiplexing the streams for a set period of time set by MST.

At processing block 710, the encoded bitstream is stored in storage or transmission medium 160. In one embodiment, output from multiplexer 125 is stored in storage or transmission medium 160. Encoder module 165 processes and write segments of data to storage or transmission medium 160. In one embodiment, these segments of data are called access units. There is one access unit generated per audio/video frame. Depending on the coding format of the output data from encoder 165, the bitstream may contain additional stream information such as time stamps and program tables. In one embodiment, timeshifting system 100 employs at delay module, which is suitable to handle all types encoder module 165 output formats. Encoder module 165 sends stream control information to access unit descriptors 305 through 320. In addition, encoder module 165 writes the bitstream to access unit storage area 325.

At processing block 715, the encoded bitstream is retrieved from storage or transmission medium 160 after a period of time. Upon playback, decoder system 170 accesses access unit descriptors 305 through 320 to determine the stream position to begin decoding. In one embodiment, the user may specify the starting position by choosing the desired delay between the recording and playback or by scanning the storage media 160 in one of the trick-play modes available within timeshifting system 100.

At processing block 720, the retrieved bitstream is decoded. In one embodiment, the decode position within storage or transmission medium 160 is determined every time the demultiplexer 135 is activated. Demultiplexer 135 begins processing the bitstream at the location specified in the selected access unit descriptor 305 through 320. Demultiplexer 135 output is fed to audio decoder 140 and video decoder 145. Audio decoder 140 and video decoder 145 operate independently. Decoded video data is transferred to video and audio output 150 and subsequently output as video data 410. Decoded audio data is transferred to video output 150 and subsequently output as audio data 420.

The specific arrangements and methods herein are merely illustrative of the principles of this invention. Numerous modifications in form and detail may be made by those skilled in the art without departing from the true spirit and scope of the invention.

What is claimed is:

1. A method comprising:
encoding a compressed domain bitstream;
storing the encoded bitstream;
retrieving the encoded bitstream after a period of time; and
decoding the retrieved bitstream.

2. The method of claim 1 wherein the period of time is programmable.

3. The method of claim 1 wherein the period of time depends upon the quality of the bit rate of encoding.

4. The method of claim 1 wherein the period of time depends upon the complexity of the encoded image.

5. The method of claim 1 wherein the compressed bitstream comprises audio data, video data, and audio and video data.

6. The method of claim 1 wherein encoding further comprises maintaining two independent time bases for audio and video input.

7. The method of claim 1 wherein encoding further comprises:
encoding an input video stream for a set period of time to generate an encoded video bitstream;
encoding an input audio stream for a set period of time to generate an encoded audio bitstream; and
multiplexing the encoded video bitstream and encoded audio bitstream to generate the compressed bitstream.

8. The method of claim 1 wherein decoding further comprises:
demultiplexing the compressed bitstream into a demultiplexed video stream and a demultiplexed audio stream;
decoding the demultiplexed video stream into an output video stream; and
decoding the demultiplexed audio stream into an output audio stream.

9. The method of claim 1 wherein retrieving the encoded bitstream beginning at an access unit pointer.

10. The method of claim 9 further comprising:
setting the position of the access unit pointer via a system start-up parameter.

11. The method of claim 9 wherein a position of the access unit pointer defines a specified time delay.

12. A system comprising:
an encoder for encoding a compressed domain bitstream;
a storage medium for storing the encoded bitstream; and
a decoder for retrieving the encoded bitstream after a period of time and decoding the retrieved bitstream.

13. The system of claim 12 wherein the period of time is programmable.

14. The system of claim 12 wherein the period of time depends upon the quality of the bit rate of encoding.

15. The system of claim 12 wherein the period of time depends upon the complexity of the encoded image.

16. The system of claim 12 wherein the compressed bitstream comprises audio data, video data, and audio and video data.

17. The system of claim 12 wherein the encoder further maintains two independent time bases for audio and video input.

18. The system of claim 12 wherein the encoder further encodes an input video stream for a set period of time to generate an encoded video bitstream, encodes an input audio stream for a set period of time to generate an encoded audio bitstream, and multiplexes the encoded video bitstream and encoded audio bitstream to generate the compressed bitstream.

19. The system of claim 12 wherein the decoder further demultiplexes the compressed bitstream into a demultiplexed video stream and a demultiplexed audio stream, decodes the demultiplexed video stream into an output video stream, and decodes the demultiplexed audio stream into an output audio stream.

20. The system of claim 12 wherein the decoder retrieves the encoded bitstream beginning at an access unit pointer.

21. The system of claim 20 wherein a background thread sets the position of the access unit pointer via a system start-up parameter.

22. The system of claim 20 wherein a position of the access unit pointer defines a specified time delay.

23. A system comprising:
means for encoding a compressed domain bitstream;
means for storing the encoded bitstream;
means for retrieving the encoded bitstream after a period of time; and
means for decoding the retrieved bitstream.

24. A computer readable medium comprising instructions, which when executed on a processor, perform a method for timeshifting the encoding and decoding of a bitstream, the system comprising:
means for encoding a compressed domain bitstream;
means for storing the encoded bitstream;
means for retrieving the encoded bitstream after a period of time; and
means for decoding the retrieved bitstream.
